(19) United States
(12) Patent Application Publication
(10) Pub. No.: US 2010/0240852 A1
(43) Pub. Date: Sep. 23, 2010

(54) HETEROATOM-CONTAINING POLYMERS AND METATHESIS POLYMERIZATION METHODS FOR MAKING SAME

(75) Inventors: Lian Leon Luo, Shoreview, MN (US); Michael Eric Benz, Ramsey, MN (US)

Correspondence Address: MEDTRONIC, INC., 710 MEDTRONIC PARKWAY NE, MINNEAPOLIS, MN, 55432-9924, US

(73) Assignee: Medtronic, Inc., Minneapolis, MN (US)

(21) Appl. No.: 12/728,978

(22) Filed: Mar. 22, 2010

Related U.S. Application Data
(60) Provisional application No. 61/162,357, filed on Mar. 23, 2009.

(51) Int. Cl. C08F 24/00; C08G 67/00

(52) U.S. Cl. 526/268; 526/270; 528/392

(57) ABSTRACT

Heteroatom-containing polymers such as polyketals, and methods of making and using such heteroatom-containing polymers are disclosed herein. The heteroatom-containing polymers can be useful for applications including, for example, medical devices and pharmaceutical compositions. In a preferred embodiment, the heteroatom-containing polymers are polyketals that are biodegradable.

### PRIORITY

This application claims priority to U.S. provisional patent application Ser. No. 61/162,357, filed on Mar. 23, 2009, and entitled “HETEROATOM-CONTAINING POLYMERS AND METATHESIS POLYMERIZATION METHODS FOR MAKING SAME” which is hereby incorporated by reference in its entirety.

### BACKGROUND

Biodegradable polymers have found uses in a wide variety of applications ranging from trash bags that decompose in landfills to implantable medical devices that biodegrade in the body. Most of these applications require that such polymers have adequate physical properties and stability to provide for suitable handling and utility prior to being subjected to end use conditions that promote biodegradation. Further, it is often preferable that these same polymers rapidly or controllably biodegrade once subjected to such end use conditions. In addition, it is often desired that biodegradable polymers used for implantable medical devices be converted under physiological conditions to materials that do not irritate or harm the surrounding tissue. Many biodegradable polymers known in the art lack the combination of physical and/or chemical properties desired to meet the needs for specific applications.

Current and new applications for biodegradable polymers continue to create a need for new polymers that provide some or all of the above-described properties.

### SUMMARY

In one aspect, the present disclosure provides monomers for metathesis polymerizations. In one embodiment, the present disclosure provides a monomer for a ring-opening metathesis polymerization (ROMP). The monomer includes at least one cyclic heteroatom-containing compound selected from the group consisting of: a compound of the formula (Formula I)

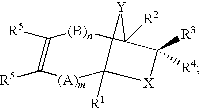

a compound of the formula (Formula II)

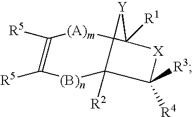

and combinations thereof; wherein: each X and Y independently represents O, S, or NR⁷; each A and B independently represents an optional organic linking group; m and n are independently zero or one; each R¹ independently represents a carbon-bonded organic group; each R², R³, R⁴, R⁵, and R⁷ independently represents H or an organic group; and two or more of R¹, R², R³, R⁴, R⁵, and R⁷ can optionally be joined to each other to form one or more rings. Methods of making the monomers, polymers prepared from the monomers, and methods of making and using such polymers, are also disclosed herein.

In another embodiment, the present disclosure provides a monomer for an acyclic diene metathesis (ADMET) polymerization including at least one cyclic heteroatom-containing compound of the formula (Formula III):

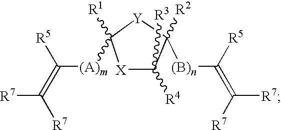

wherein: each R¹ independently represents a carbon-bonded organic group; each A and B independently represents an optional organic linking group; m and n are independently zero or one; each R², R³, R⁴, R⁵, and R⁷ independently represents H or an organic group; and two or more of R¹, R², R³, R⁴, R⁵, and R⁷ can optionally be joined to each other to form one or more rings. Methods of making the monomers, polymers prepared from the monomers, and methods of making and using such polymers, are also disclosed herein.

The presently disclosed methods of preparing heteroatom-containing polymers (e.g., polyketal polymers) can offer advantages over other methods known in the art for preparing heteroatom-containing polymers such as polyketals. For example, the presently disclosed methods are convenient for preparing heteroatom-containing polymers such as polyketals without the need to remove small molecule byproducts (e.g., water and other small molecules such as alcohols) typically formed in known condensation type polymerizations.

In another aspect, the present disclosure provides a polymer including two or more repeat units selected from the group consisting of: a repeat unit of the formula (Formula VIII):

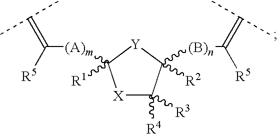

a repeat unit of the formula (Formula IX):

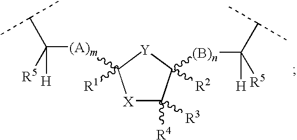

and combinations thereof; wherein: each X and Y independently represents O, S, or NR⁷; each A and B independently represents an optional organic linking group; m and n are independently zero or one; each R¹ independently represents a carbon-bonded organic group; each R², R³, R⁴, R⁵, and R⁷ independently represents H or an organic group; and two or more of R¹, R², R³, R⁴, R⁵, and R⁷ can optionally be joined to each other to form one or more rings. The polymers and compositions including the polymers can be useful for applications including, for example, medical devices and pharmaceutical compositions. In a preferred embodiment, hydrolysis of the heteroatom-containing polymers (e.g., polyketal polymers) leads to biodegradation of the polymer.

The terms “comprises” and variations thereof do not have a limiting meaning where these terms appear in the description and claims.

As used herein, “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

The above summary is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a nuclear magnetic resonance spectrum of a cyclic heteroatom-containing compound of Formula III (i.e., 2-Methyl-2-(3-butenyl)-5-vinyl-1,3-dioxolane) prepared as described in the Examples.

### DETAILED DESCRIPTION OF ILLUSTRATIVE EMBODIMENTS

A wide variety of biodegradable and/or bioerodible polymers are known in the art. As used herein, “biodegradable” and “bioerodible” are used interchangeably and are intended to broadly encompass materials including, for example, those that tend to break down upon exposure to physiological environments. Biodegradable and/or bioerodible polymers known in the art include, for example, linear aliphatic polyester homopolymers (e.g., polyglycolide, polylactide, polycaprolactone, and polyhydroxybutyrate) and copolymers (e.g., poly(glycolide-co-lactide), poly(glycolide-co-caprolactone), poly(glycolide-co-trimethylenecarbonate), poly(lactic acid-co-lysine), poly(lactide-co-urethane), poly(ester-co-amide)); polyanhydrides; and poly(orthoesters). However, many of these polymers lack the combination of physical and/or chemical properties desired for certain applications, particularly in the medical and pharmaceutical fields.

For example, polyglycolide and polylactide homo- and co-polymers are converted under physiological conditions to products including glycolic acid and lactic acid, respectively. For certain medical device applications, the formation of acidic products can limit the utility of such biodegradable polymers. Further, many of the biodegradable polymers noted above biodegrade at a slower rate than desired for specific applications.

Certain polyketals are also known to be biodegradable polymers. As used herein, a “polyketal” refers to a homo- or co-polymer that includes two or more (i.e., a plurality) of ketal repeat units. As used herein, a “ketal” repeat unit is a unit including a ketal-containing group that is repeated in the polymer at least once. A ketal group is a group that includes an —O—C(M)(N)—O— functionality with the proviso that neither M nor N is hydrogen (e.g., an acetal-containing group) or oxygen (e.g., an orthoester-containing group).

Further, known methods for preparing some of the known biodegradable polymers noted above (including, for example, known polyketals) typically involve condensation type polymerizations that form small molecule byproducts (e.g., water and other small molecules such as alcohols) during the polymerization reaction. The presence of such small molecule byproducts in the reaction mixture can adversely impact the molecular weight of the resultant polymer, and removal of such small molecule byproducts during the polymerization process can lead to a more complicated and expensive process.

The limitations of known methods of making polyketals has limited the commercial use of such polymers. A typical known method includes, for example, condensing or reacting a diol with a ketone or ketal to form a polyketal in a step growth polymerization process. However, in preparing polymers in a step growth polymerization process that have sufficient molecular weight for certain medical device applications, the strict control of reactant stoichiometries and the concurrent removal of byproducts formed can lead to difficult, expensive, and/or poorly reproducible processes.

The presently disclosed methods of preparing heteroatom-containing polymers (e.g., polyketal polymers) can offer advantages over other methods known in the art for preparing polyketals. For example, certain presently disclosed methods (e.g. ring-opening metathesis polymerization methods) can be convenient for preparing heteroatom-containing polymers such as polyketals without the need to remove small molecule byproducts (e.g., water and other small molecules such as alcohols) typically formed in known condensation type polymerizations. For another example, other certain presently disclosed methods (e.g. acyclic diene metathesis polymerization methods) can be convenient for preparing heteroatom-containing polymers such as polyketals, wherein small molecule byproducts (e.g., ethylene) can be readily removed.

In contrast, the present disclosure provides heteroatom-containing polymers (e.g., polyketal polymers) and convenient methods of preparing such polymers. Notably the presently disclosed heteroatom-containing polymers (e.g., polyketal polymers) include polymers that are not converted under physiological conditions to acidic products. Further, the present disclosure provides heteroatom-containing polymers (e.g., polyketal polymers) that can biodegrade at a sufficiently high rate to enable them to be considered for use in specific applications.

In one aspect, the present disclosure provides monomers for metathesis polymerizations. In one embodiment, the present disclosure provides a monomer for a ring-opening metathesis polymerization (ROMP). The monomer includes at least one cyclic heteroatom-containing compound selected from the group consisting of: a compound of the formula (Formula I)

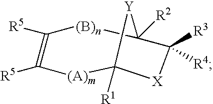

a compound of the formula (Formula II)

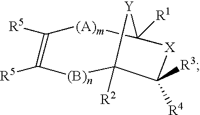

and combinations thereof; wherein: each X and Y independently represents O, S, or NR⁷; each A and B independently represents an optional organic linking group; m and n are independently zero or one; each R¹ independently represents a carbon-bonded organic group; each R², R³, R⁴, R⁵, and R⁷ independently represents H or an organic group; and two or more of R¹, R², R³, R⁴, R⁵, and R⁷ can optionally be joined to each other to form one or more rings. As used herein, a “carbon-bonded” organic group means that the organic group is bonded to the other indicated group(s) by one or more bonds to one or more carbon atoms of the organic group.

In another embodiment, the present disclosure provides a monomer for an acyclic diene metathesis (ADMET) polymerization including at least one cyclic heteroatom-containing compound of the formula (Formula III):

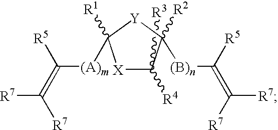

wherein: each X and Y independently represents O, S, or NR⁷; each A and B independently represents an optional organic linking group; m and n are independently zero or one; each R¹ independently represents a carbon-bonded organic group; each R², R³, R⁴, R⁵, and R⁷ independently represents H or an organic group; and two or more of R¹, R², R³, R⁴, R⁵, and R⁷ can optionally be joined to each other to form one or more rings. The wavy bonds in the formulas herein are used to indicate unspecified stereochemistry. R¹ and R² can be oriented either cis or trans about the illustrated 5-membered heterocyclic ring.

In certain embodiments of monomers of Formula I, Formula II, and/or Formula III, X and Y each represent O; each A and B independently represents an optional divalent carbon-bonded C1-C4 organic linking group; m and n are independently zero or one; each R¹ independently represents a C1-C10 carbon-bonded organic group; and each R², R³, R⁴, R⁵, and R⁷ independently represents H or a C1-C10 organic group. In preferred embodiments, none of R¹, R², R³, R⁴, R⁵, and R⁷ are joined to each other to form rings.

In certain embodiments of monomers of Formula I, Formula II, and/or Formula III, X and Y each represent O; each A and B independently represents an optional divalent carbon-bonded C1-C2 organic linking group (e.g., —CH₂—; —CH₂CH₂—; or —CH═CH—); m and n are independently zero or one; each R¹ independently represents a carbon-bonded phenyl group or a carbon-bonded C1-C4 aliphatic or alicyclic group; and each R², R³, R⁴, R⁵, and R⁷ independently represents H, a phenyl group, or a C1-C4 aliphatic or alicyclic group. In preferred embodiments, none of R¹, R², R³, R⁴, R⁵, and R⁷ are joined to each other to form rings.

In certain embodiments of monomers of Formula I, Formula II, and/or Formula III, X and Y each represent O; m=n=zero; each R¹ independently represents methyl; and each R², R³, R⁴, R⁵, and R⁷ represents H.

As used herein, the term “organic group” is used for the purpose of this disclosure to mean a hydrocarbon group that is classified as an aliphatic group, cyclic group, or combination of aliphatic and cyclic groups (e.g., alkaryl and aralkyl groups). In the context of the present disclosure, suitable organic groups for monomers and polymers of this disclosure are those that do not interfere with the metathesis polymerization reactions disclosed herein. In the context of the present disclosure, the term “aliphatic group” means a saturated or unsaturated linear or branched hydrocarbon group. This term is used to encompass alkyl, alkenyl, and alkynyl groups, for example. The term “alkyl group” means a saturated linear or branched monovalent hydrocarbon group including, for example, methyl, ethyl, n-propyl, isopropyl, tent-butyl, amyl, heptyl, and the like. The term “alkenyl group” means an unsaturated, linear or branched monovalent hydrocarbon group with one or more olefinically unsaturated groups (i.e., carbon-carbon double bonds), such as a vinyl group. The term “alkynyl group” means an unsaturated, linear or branched monovalent hydrocarbon group with one or more carbon-carbon triple bonds. The term “cyclic group” means a closed ring hydrocarbon group that is classified as an alicyclic group, aromatic group, or heterocyclic group. The term “alicyclic group” means a cyclic hydrocarbon group having properties resembling those of aliphatic groups. The term “aromatic group” or “aryl group” means a mono- or polynuclear aromatic hydrocarbon group. The term “heterocyclic group” means a closed ring hydrocarbon in which one or more of the atoms in the ring is an element other than carbon (e.g., nitrogen, oxygen, sulfur, etc.).

As a means of simplifying the discussion and the recitation of certain terminology used throughout this application, the terms “group” and “moiety” are used to differentiate between chemical species that allow for substitution or that may be substituted and those that do not so allow for substitution or may not be so substituted. Thus, when the term “group” is used to describe a chemical substituent, the described chemical material includes the unsubstituted group and that group with nonperoxidic O, N, S, Si, or F atoms, for example, in the chain as well as carbonyl groups or other conventional substituents. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, tert-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, Pert-butyl, and the like.

Thus, in cyclic heteroatom-containing compounds of Formula I, Formula II, and/or Formula III as disclosed herein above, any of the R substituents that are “organic groups” can include as at least a portion thereof, for example, a cyclic heteroatom-containing functionality (e.g., at least a portion of Formula I, Formula II, and/or Formula III); an imagable functionality (i.e., a functionality visible in an imaging system, such as, for example, one or more radiopaque functionalities such as iodinated groups, ferromagnetic functionalities, and magnetic susceptible functionalities such as Fe, Cr, Ni, and Gd); a latent reactive functionality (e.g., ethylenic unsaturation and/or heteroatom-containing rings suitable for latent crosslinking after polymerization); or combinations thereof. Thus, the cyclic heteroatom-containing compounds of Formula I, Formula II, and/or Formula III as disclosed herein above include not only monofunctional compounds, but additionally di- and poly-functional compounds.

Monomers of Formula I and Formula II can be prepared by suitable methods known to one of skill in the art. Cycloaddition reactions (e.g., Diels-Alder reactions) can be particularly useful for preparing monomers of Formula I and/or Formula II. For example, monomers of Formula I and/or Formula II (e.g., wherein m=n=zero) can be prepared by combining components under conditions effective for a cycloaddition reaction to form the monomer, wherein the components include: a compound of the formula (Formula IV)

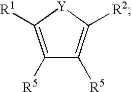

and a compound of the formula (Formula V)

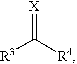

wherein X, Y, R¹, R², R³, R⁴, R⁵, and R⁷ are as defined above.

Typical conditions effective to form the monomer can include heating a neat mixture of the components. In some embodiments, a catalyst (e.g., a Lewis acid catalyst such as AlCl₃, SnCl₄, and EtAlCl₂) can be used to accelerate the cycloaddition reaction. See, for example, Snider et al., J. Organic Chem. 48 (1983) 3003-3010.

Monomers of Formula III can be prepared by suitable methods known to one of skill in the art. For example, monomers of Formula III can be prepared by combining components under conditions effective for a cyclization reaction (e.g., a condensation reaction) to form the monomer, the components comprising: a compound of the formula (Formula VI)

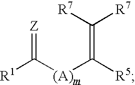

and a compound of the formula (Formula VII)

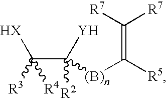

wherein X, Y, A, B, m, n, R¹, R², R³, R⁴, R⁵, and R⁷ are as defined above.

Typical conditions effective to form the monomer can include conditions effective for condensation reactions such as removal of formed water. Typical conditions can include one or more of heating the combined components either neat or in the presence of a solvent (e.g., protic or aprotic); presence of an inert atmosphere; and presence of an acid catalyst (e.g., Brønsted or Lewis acid).

In another aspect, the present disclosure provides a method of preparing a heteroatom-containing polymer such as a polyketal. In one embodiment, the method includes combining components including a ring-opening metathesis polymerization catalyst and a monomer of Formula I and/or Formula II under conditions effective to polymerize the at least one cyclic heteroatom-containing compound and form the polymer. In another embodiment, the method includes combining components including an acyclic diene metathesis (ADMET) catalyst and a monomer of Formula III under conditions effective to polymerize the at least one cyclic heteroatom-containing compound and form the polymer. In certain embodiments, the components can be combined in a mold to prepare a medical device.

Typically, the polymerization proceeds by ring opening metathesis polymerization (ROMP) or acyclic diene metathesis (ADMET) polymerization, although isomerizations of rings are also possible during the polymerization process. Metathesis polymerizations are typically advantageous in that molecular weight can be readily controlled by variables including, for example, the ratio of metathesis catalyst to monomer. Typically the polymerization can be initiated thermally in the presence of a suitable metathesis catalyst. Typically, the polymerization process proceeds through a cationic, an anionic, a free radical, and/or an organometallic pathway.

A metathesis catalyst can be used to initiate and/or propagate the polymerization reaction. A wide variety of metathesis catalysts can be used that are known in the art to catalyze ring opening metathesis polymerizations (ROMP) and/or acyclic diene metathesis (ADMET) polymerizations. Typically, the metathesis catalyst provides for polymerization through a cationic, an anionic, a free radical, and/or an organometallic pathway. The metathesis catalyst may be present in catalytic amounts, or alternatively, may be used in stoichiometric amounts with partial or total consumption of the metathesis catalyst during the polymerization reaction.

In some embodiments, the metathesis catalyst includes an organometallic compound. Suitable organometallic compounds include those disclosed in, for example, Grubbs, Tetrahedron 60 (2004) 7117-7140; Grubbs et al., Tetrahedron 54 (1998) 4413-4450; Nicolaou et al., J. Amer. Chem. Soc. 119 (1997) 7960-7973; Kanaoka et al., Macromolecules 28 (1995) 4707-4713; Weck et al., Macromolecules 29 (1996) 1789-1793; Lynn et al., J. Amer. Chem. Soc. 118 (1996) 784-790; Fraser et al., Macromolecules 28 (1995) 7256-7261; Haigh et al., Tetrahedron 60 (2004) 7217-7224; Novak et al., J. Amer. Chem. Soc. 110 (1988) 7542-7543; Chen et al., Macromolecules 28 (1995) 2147-2154; Bielawski et al., J. Amer. Chem. Soc. 122 (2000) 12872-12873; U.S. Pat. No. 6,884,859 (Grubbs et al.); and the like. Exemplary metathesis catalysts includes transition metal catalysts (e.g., Ru and/or W). A particularly useful metathesis catalyst includes a ruthenium alkylidene.

The ratio of the metathesis catalyst to the monomers can be varied as desired, and is typically selected to provide the desired reaction time at the selected reaction temperature for the specific metathesis catalyst. The ratio of the metathesis catalyst to the monomers can also be varied to influence the molecular weight of the resulting polymers, with lower ratios typically resulting in higher molecular weights. In some embodiments, at least 0.0000001 mole %, sometimes at least 0.000001 mole %, and other times at least 0.00001 mole % of metathesis catalyst is used, based on the total moles of monomers and metathesis catalyst. In some embodiments, at most 30 mole %, sometimes at most 20 mole %, and other times at most 10 mole % of metathesis catalyst is used, based on the total moles of monomers and metathesis catalyst.

In certain embodiments, conditions effective for metathesis polymerization include combining at least 0.1 part per million by weight of the catalyst, based on the total weight of monomers and catalyst. In other certain embodiments, conditions effective for metathesis polymerization include combining at most 10 weight percent of the catalyst, based on the total weight of monomers and catalyst.

Suitable metathesis catalysts can be capable of initiating one polymer chain (i.e., monofunctional catalysts). However, metathesis catalysts that are capable of initiating more than one polymer chain (i.e., difunctional or polyfunctional catalysts such as, for example, heterogeneous catalysts and/or clusters) can also be suitable for use in the presently disclosed methods.

In certain embodiments, components including the one or more monomers and the metathesis catalyst can be combined neat (e.g., without adding a solvent). In other certain embodiments, components including the one or more monomers and the metathesis catalyst can be combined in a dry organic solvent at a concentration selected to provide a convenient reaction rate. Typically and preferably, at least a portion of the components are combined under an inert atmosphere. The reaction temperature can be selected and/or varied as desired to provide a convenient reaction rate. In even other embodiments, conditions effective for metathesis polymerization can include combining at least a portion of the components under physiological conditions.

In certain embodiments, the method of preparing a heteroatom-containing polymer can further include combining polymerizable compounds in addition to monomers of Formula I, Formula II, and/or Formula III. The additional polymerizable compounds can be monofunctional compounds, polyfunctional compounds, imagable compounds, compounds having latent reactive sites, or combinations thereof.

In certain embodiments, the additional polymerizable compound can be a cyclic heteroatom-containing compound different than monomers of Formula I, Formula II, and/or Formula III. Additional polymerizable compounds can include, for example, monocyclic alkenes (e.g., cyclohexene and cyclooctene), polycyclic alkenes (e.g., norbornene), non-cyclic dienes (e.g., α,ω-dienes such as 1,5-hexadiene and 1,7-octadiene), monocyclic dienes (e.g., 1,3-cyclohexadiene and 1,5-cyclooctadiene), polycyclic dienes (e.g., norbornadiene), non-cyclic polyenes (e.g., 1,3,5-hexatriene and 1,3,7-octatriene), monocyclic polyenes (e.g., 1,3,5-cyclooctatriene), polycyclic polyenes, and combinations thereof. In certain embodiments, the additional polymerizable compounds can also include various amounts of non-cyclic alkenes (e.g., ethylene, 1-propene, and 1-butene).

In another aspect, the present disclosure provides a polymer including two or more repeat units selected from the group consisting of: a repeat unit of the formula (Formula VIII):

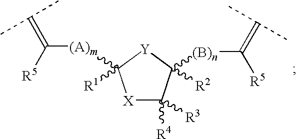

a repeat unit of the formula (Formula IX):

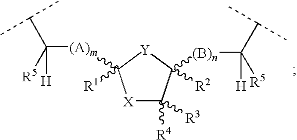

and combinations thereof; wherein: each X and Y independently represents O, S, or NR⁷; each A and B independently represents an optional organic linking group; m and n are independently zero or one; each R¹ independently represents a carbon-bonded organic group; each R², R³, R⁴, R⁵, and R⁷ independently represents H or an organic group; and two or more of R¹, R², R³, R⁴, R⁵, and R⁷ can optionally be joined to each other to form one or more rings. R¹ and R² can be oriented either cis or trans about the illustrated 5-membered heterocyclic ring for one, more than one, or all repeat units.

The polymers disclosed herein can have two or more consecutive repeat units connected in head-to-tail orientations. Alternatively, or in addition to, the polymers disclosed herein can have two or more consecutive repeat units connected in head-to-head and/or tail-to-tail orientations.

In certain embodiments of repeat units of Formula VIII and/or Formula IX, X and Y each represent O; each A and B independently represents an optional divalent carbon-bonded C1-C4 organic linking group; m and n are independently zero or one; each R¹ independently represents a carbon-bonded C1-C10 organic group; and each R², R³, R⁴, R⁵, and R⁷ independently represents H or a C1-C10 organic group. In preferred embodiments, none of R¹, R², R³, R⁴, R⁵, and R⁷ are joined to each other to form rings.

In certain embodiments of repeat units of Formula VIII and/or Formula IX, X and Y each represent O; each A and B independently represents an optional divalent carbon-bonded C1-C2 organic linking group; m and n are independently zero or one; each R¹ independently represents a carbon-bonded phenyl group or a carbon-bonded C1-C4 aliphatic or alicyclic group; and each R², R³, R⁴, R⁵, and R⁷ independently represents H, a phenyl group, or a C1-C4 aliphatic or alicyclic group. In preferred embodiments, none of R¹, R², R³, R⁴, R⁵, and R⁷ are joined to each other to form rings.

In certain embodiments of repeat units of Formula VIII and/or Formula IX, X and Y each represent O; m=n=zero; each R¹ independently represents methyl; and each R², R³, R⁴, R⁵, and R⁷ represents H.

In certain embodiments the polymer is an unsaturated polymer that includes one or more carbon-carbon double bonds, and does not include a repeat unit of Formula IX. In certain embodiments the polymer is an unsaturated polymer that includes one or more carbon-carbon double bonds, and further includes a repeat unit of Formula IX.

For embodiments in which the polymer is an unsaturated polymer including one or more carbon-carbon double bonds, further reactions can be carried out to modify the polymer. In some embodiments a compound of formula X—Y can be added to one or more of the carbon-carbon double bonds (e.g., —CH═CH—) to form an adduct of the formula —CH(X)CH(Y)—.

For example, in one embodiment, one or more carbon-carbon double bonds can be hydrogenated to form a repeat unit of Formula IX. Hydrogenation methods are well known in the art and include, for example, exposure to molecular hydrogen in the presence of a platinum catalyst.

In another embodiment, one or more carbon-carbon double bonds can be reacted with a Brønsted acid or a Lewis acid. For example, the one or more carbon-carbon double bonds can be reacted with one or more of HCl, HBr, HI, and H₂SO₄. For another example, the one or more carbon-carbon double bonds can be reacted with one or more of a halogen (e.g., Cl₂, Br₂, and I₂), an interhalogen (e.g., ClF, BrCl, ICl, IBr, ClF₃, BrF₃, ICl₃, ClF₅, BrF₅, and IF₅), a boron hydride (e.g., B₂H₅), a hypohalous acid (e.g., HOCl, HOBr, and HOI), a sulfenyl chloride (e.g., Cl₃CSCl, 2,4-(O₂N)₂C₆H₃Cl), and mercuric acetate. In some embodiments, the polymers formed from such reactions can be radiopaque and/or have antimicrobial properties.

In another embodiment, one or more carbon-carbon double bonds can be oxidized with an oxidizing agent to form hydroxylated and/or epoxidized polymers.

In another embodiment, one or more carbon-carbon double bonds can be reacted with sulfur or sulfur-containing compounds (e.g., S₈ or organosulfur compounds), for example, to form crosslinks.

In another embodiment, one or more carbon-carbon double bonds can be hydrosilylated. Hydrosilylation methods are well known in the art and include, for example, exposure to a Si—H containing compound in the presence of a platinum catalyst.

A single cyclic heteroatom-containing compound as described herein can be used to prepare a homopolymer as disclosed herein. Alternatively, a cyclic heteroatom-containing compound as described herein can be used in combination with one or more additional polymerizable compounds to prepare a copolymer as disclosed herein.

In certain embodiments, the additional polymerizable compound can be a cyclic heteroatom-containing compound different than monomers of Formula I, Formula II, and/or Formula III. Additional polymerizable compounds can include, for example, monocyclic alkenes (e.g., cyclohexene and cyclooctene), polycyclic alkenes (e.g., norbornene), non-cyclic dienes (e.g., α,ω-dienes such as 1,5-hexadiene and 1,7-octadiene), monocyclic dienes (e.g., 1,3-cyclohexadiene and 1,5-cyclooctadiene), polycyclic dienes (e.g., norbornadiene), non-cyclic polyenes (e.g., 1,3,5-hexatriene and 1,3,7-octatriene), monocyclic polyenes (e.g., 1,3,5-cyclooctatriene), polycyclic polyenes, and combinations thereof. In certain embodiments, the additional polymerizable compounds can also include various amounts of non-cyclic alkenes (e.g., ethylene, 1-propene, and 1-butene).

In the above-disclosed polymers, any of the R substituents that are “organic groups” can include as at least a portion thereof, for example, a cyclic heteroatom-containing functionality (e.g., at least a portion of Formula I, Formula II, and/or Formula III); an imagable functionality (e.g., one or more radiopaque functionalities such as iodinated groups, ferromagnetic functionalities, and magnetic susceptible functionalities such as Fe, Cr, Ni, and Gd); a latent reactive functionality (e.g., ethylenic unsaturation and/or heteroatom-containing rings suitable for latent crosslinking after polymerization); or combinations thereof.

The polymers disclosed herein can include a single cyclic heteroatom-containing repeat unit (i.e., a homopolymer), or two or more different repeat units (i.e., a copolymer). In such copolymers, the two or more different repeat units can all be different cyclic heteroatom-containing repeat units of Formula VIII and/or Formula IX, or alternatively, one or more cyclic heteroatom-containing repeat units of Formula VIII and/or Formula IX in combination with one or more repeat units that are not of Formula VIII and/or Formula IX (e.g., non-cyclic alkenes, monocyclic alkenes, polycyclic alkenes, non-cyclic dienes, monocyclic dienes, polycyclic dienes, non-cyclic polyenes, monocyclic polyenes, polycyclic polyenes, and combinations thereof). The polymers disclosed herein can be linear polymers, crosslinkable polymers, and/or crosslinked polymers.

Copolymers as disclosed herein can be random copolymers, alternating copolymers, block copolymers, graft copolymers, or combinations thereof. For example, mixtures of monomers can be combined with a polymerization agent to prepare random and/or alternating copolymers. For another example, one or more monomers can be combined with a polymerization agent and allowed to react until all the monomer is consumed, followed by the addition of one or more different monomers, and optionally additional polymerization agent (which can be the same or different than the first polymerization agent), which are then allowed to react to prepare block and/or graft copolymers.

Block copolymers in which at least one block of the block copolymer is a polyketal block including two or more repeat units selected from the group consisting of repeat units of Formula VIII, repeat units of Formula IX, and combinations thereof, can be of particular interest for certain applications. The at least one other block of such block copolymers can be selected from blocks having a wide variety of repeat units including, for example, alpha-hydroxy alkanoates, beta-hydroxy alkanoates, gamma-hydroxy alkanoates, delta-hydroxy alkanoates, epsilon-hydroxy alkanoates, or combinations thereof. In certain embodiments, the at least one other block of such block copolymers can be a poly(orthoester) block. In other certain embodiments, the at least one other block of such block copolymers can be a poly(alkyleneglycol) block including alkylene glycol repeat units.

Typically and preferably, the heteroatom-containing polymers (e.g., polyketal polymers) disclosed herein are biodegradable. Typically, the average molecular weight (and preferably the weight average molecular weight) of the polymers disclosed herein is at least 1000 Daltons, and sometimes at least 2000 Daltons, 5,000 Daltons, or even 10,000 Daltons or more. Average molecular weights of the polymers disclosed herein can be as high as desired for specific applications. Typically, the average molecular weight (and preferably the weight average molecular weight) of the polymers disclosed herein is at most 10,000,000 Daltons, and sometimes at most 5,000,000 Daltons, 2,000,000 Daltons, or even 1,000,000 Daltons. Typically the polydispersity index of the polymers disclosed herein is at most 3, and sometimes at most 2.5, and other times at most 2.0.

For certain applications, a heteroatom-containing polymer (e.g., polyketal polymer) as disclosed herein can be blended with another polymer (e.g., the same or different than the heteroatom-containing polymers disclosed herein) to provide the desired physical and/or chemical properties. For example, two heteroatom-containing polymers having different molecular weights can be blended to optimize the release rate of a biologically active agent. For another example, two heteroatom-containing polymers having different repeat units can be blended to provide desired physical and/or chemical properties. For even another example, a heteroatom-containing polymer can be blended with another polymer that is not a heteroatom-containing polymer to provide desired physical and/or chemical properties.

Heteroatom-containing polymers such as polyketals as disclosed herein can be used in various combinations for various applications. They can be used as tissue-bulking agents in urological applications for bulking the urinary sphincter to prevent stress incontinence or in gastrological applications for bulking of the lower esophageal sphincter to prevent gastroesophageal reflux disease. They can be used for replacements for nucleus pulposis or repair of annulus in intervertebral disc repair procedures. They can be used as tissue adhesives or sealants. They can be used as surgical void fillers, for example, in reconstructive or cosmetic surgery (e.g., for filling a void after tumor removal). They can be used to repair aneurysms, hemorrhagic stroke or other conditions precipitated by failure of a blood vessel. They can be used to prevent surgical adhesions. Heteroatom-containing polymers such as polyketals as disclosed herein can further be used for applications such as scaffolds or supports for the development and/or growth of cells for applications including, for example, tissue engineering and the fabrication of artificial organs.

Heteroatom-containing polymers such as polyketals as disclosed herein can be used in injectable compositions. Such injectable compositions could be used as tissue bulking agents (e.g., for the treatment of urinary stress incontinence, for the treatment of gastroesophageal reflux disease, or serving to augment a degenerated intervertebral disc), void fillers (e.g., in cosmetic or reconstructive surgery, such as serving as a replacement for the nucleus pulposis), or as an injectable drug delivery matrix.

In some embodiments, no additives would be needed to form an injectable composition. In some embodiments, one or more polymers can be combined with a solvent such as N-methyl-2-pyrrolidone or dimethylsulfoxide (DMSO), which are fairly biocompatible solvents. The solvent can diffuse away after injection and the polymer can remain in place. Such injectable materials can be applied to a desired site (e.g., a surgical site) using a syringe, catheter, or by hand.

Also, injectable compositions could include crosslinkers (such as diacrylates), plasticizers (such as triethyl citrate), lipids (soybean oil), poly(ethylene glycol) (including those with the ends blocked with methyls or similar groups), silicone oil, partially or fully fluorinated hydrocarbons, N-methyl-2-pyrrolidone, or mixtures thereof.

Polymers of the present disclosure can be used in combination with a variety of particulate materials. For example, they can be used with moisture curing ceramic materials (e.g., tricalcium phosphate) for vertebroplasty cements, bone void filling (due to disease such as cancer or due to fracture). They can be used in combination with inorganic materials such as hydroxylapatite to form pastes for use in bone healing, sealing, filling, repair, and replacement. They can be used as or in combination with polymer microspheres that can be reservoirs for a biologically active agent such as a protein, DNA plasmid, RNA plasmid, antisense agent, etc.

Alternatively, or in addition to, heteroatom-containing polymers such as polyketals as disclosed herein can be used in combination with other materials to form a composite (e.g., a polymer having an additive therein). In addition to one or more heteroatom-containing polymers, composites can include a wide variety of additives, and particularly particulate additives, such as, for example, fillers (e.g., including particulate, fiber, and/or platelet material), other polymers (e.g., polymer particulate materials such as polytetrafluoroethylene can result in higher modulus composites), imaging particulate materials (e.g., barium sulfate for visualizing material placement using, for example, fluoroscopy), biologically derived materials (e.g., bone particles, cartilage, demineralized bone matrix, platelet gel, and combinations thereof), and combinations thereof. Additives can be dissolved, suspended, and/or dispersed within the composite. For particulate additives, the additive is typically dispersed within the composite.

Heteroatom-containing polymers such as polyketals as disclosed herein can be combined with fibers, woven or nonwoven fabric for reconstructive surgery, such as the in situ formation of a bone plate or a bone prosthesis.

In certain embodiments, one or more heteroatom-containing polymers such as polyketals as disclosed herein can be shaped to form a medical device, preferably a biodegradable medical device. The one or more polymers can be shaped by methods known in the art including compression molding, injection molding, casting, extruding, milling, blow molding, or combinations thereof. As used herein, a “medical device” includes devices that have surfaces that contact tissue, bone, blood, or other bodily fluids in the course of their operation, which fluids are subsequently used in patients. This can include, for example, extracorporeal devices for use in surgery such as blood oxygenators, blood pumps, blood sensors, tubing used to carry blood, and the like which contact blood which is then returned to the patient. This can also include endoprostheses implanted in blood contact in a human or animal body such as vascular grafts, stents, pacemaker leads, heart valves, and the like, that are implanted in blood vessels or in the heart. This can also include devices for temporary intravascular use such as catheters, guide wires, and the like which are placed into the blood vessels or the heart for purposes of monitoring or repair. A medical device can also be fabricated by polymerizing components including monomers of Formula I, Formula II, and/or Formula III in a suitable mold.

Heteroatom-containing polymers such as polyketals as disclosed herein can also be coated onto a substrate if desired. A coating mixture of the polymer can be prepared using solvents such as toluene, chloroform, tetrahydrofuran, perfluorinated solvents, and combinations thereof. Preferred solvents include those that can be rendered moisture-free and/or those that have no active hydrogens. The coating mixture can be applied to an appropriate substrate such as uncoated or polymer coated medical wires, catheters, stents, prostheses, penile inserts, and the like, by conventional coating application methods. Such methods include, but are not limited to, dipping, spraying, wiping, painting, solvent swelling, and the like. After applying the coating solution to a substrate, the solvent is preferably allowed to evaporate from the coated substrate.

The materials of a suitable substrate include, but are not limited to, polymers, metal, glass, ceramics, composites, and multilayer laminates of these materials. The coating may be applied to metal substrates such as the stainless steel used for guide wires, stents, catheters and other devices. Organic substrates that may be coated with the polymers of this disclosure include, but are not limited to, polyether-polyamide block copolymers, polyethylene terephthalate, polyetherurethane, polyesterurethane, other polyurethanes, silicone, natural rubber, rubber latex, synthetic rubbers, polyester-polyether copolymers, polycarbonates, and other organic materials.

Additives that can be combined with a heteroatom-containing polymer as disclosed herein to form a composition include, but are not limited to, wetting agents for improving wettability to hydrophobic surfaces, viscosity and flow control agents to adjust the viscosity and thixotropy of the mixture to a desired level, antioxidants to improve oxidative stability of the coatings, dyes or pigments to impart color or radiopacity, and air release agents or defoamers, cure catalysts, cure accelerants, plasticizers, solvents, stabilizers (cure inhibitors, pot-life extenders), and adhesion promoters.

Of particular interest for medical and pharmaceutical applications (e.g., drug delivery matrices) are compositions that include one or more heteroatom-containing polymers as disclosed herein and a biologically active agent. As used herein, a “biologically active agent” is intended to be broadly interpreted as any agent capable of eliciting a response in a biological system such as, for example, living cell(s), tissue(s), organ(s), and being(s). Biologically active agents can include natural and/or synthetic agents. Thus, a biologically active agent is intended to be inclusive of any substance intended for use in the diagnosis, cure, mitigation, treatment, or prevention of disease or in the enhancement of desirable physical or mental development and conditions in a subject. The term “subject” as used herein is taken to include humans, sheep, horses, cattle, pigs, dogs, cats, rats, mice, birds, reptiles, fish, insects, arachnids, protists (e.g., protozoa), and prokaryotic bacteria. Preferably, the subject is a human or other mammal.

A preferred class of biologically active agents includes drugs. As used herein, the term “drug” means any therapeutic agent. Suitable drugs include inorganic and organic drugs, without limitation, and include drugs that act on the peripheral nerves, adrenergic receptors, cholinergic receptors, nervous system, skeletal muscles, cardiovascular system, smooth muscles, blood circulatory system, synaptic sites, neuro-effector junctional sites, endocrine system, hormone systems, immunological system, reproductive system, skeletal system, autocoid systems, alimentary and excretory systems (including urological systems), histamine systems, and the like. Such conditions, as well as others, can be advantageously treated using compositions as disclosed herein.

Preferred classes of drugs include, for example, Plasmid DNA, genes, antisense oligonucleotides and other antisense agents, peptides, proteins, protein analogs, siRNA, shRNA, miRNA, ribozymes, DNAzymes and other DNA based agents, viral and non-viral vectors, lyposomes, cells, stem cells, antineoplastic agents, antiproliferative agents, antithrombogenic agents, anticoagulant agents, antiplatelet agents, antibiotics, anti-inflammatory agents, antimitotic agents, immunosuppressants, growth factors, cytokines, hormones, and combinations thereof.

Suitable drugs can have a variety of uses including, but are not limited to, anticonvulsants, analgesics, antiparkinsons, antiinflammatories (e.g., ibuprofen, fenbufen, cortisone, and the like), calcium antagonists, anesthetics (e.g., benoxinate, benzocaine, procaine, and the like), antibiotics (e.g., ciprofloxacin, norfloxacin, clofoctol, and the like), antimalarials, antiparasitics, antihypertensives, antihistamines, antipyretics, alpha-adrenergic agonists, alpha-blockers, biocides, bactericides, bronchial dilators, beta-adrenergic blocking drugs, contraceptives, cardiovascular drugs, calcium channel inhibitors, depressants, diagnostics, diuretics, electrolytes, enzymes, hypnotics, hormones, hypoglycemics, hyperglycemics, muscle contractants, muscle relaxants, neoplastics, glycoproteins, nucleoproteins, lipoproteins, ophthalmics, psychic energizers, sedatives, steroids sympathomimetics, parasympathomimetics, tranquilizers, urinary tract drugs, vaccines, vaginal drugs, vitamins, collagen, hyaluronic acid, nonsteroidal anti-inflammatory drugs, angiotensin converting enzymes, polynucleotides, polypeptides, polysaccharides, and the like.

Specific examples of drugs include those selected from the group consisting of salicylic acid, fenbufen, cortisone, ibuprofen, diflunisal; sulindac, difluprednate, prednisone, medrysone, acematacin, indomethacin, meloxicam, camptothecin, benoxinate, benzocaine, procaine, ciprofloxacin, norfloxacin, clofoctol, clonidine, baclofen, bupivacaine, triamcinolone hexacetonide, tacrolimus, resveratrol, fluocinolone, curcumin, withaferin A, dexamethasone, and combinations thereof.

Compositions including a biologically active agent and a heteroatom-containing polymer as disclosed herein and can be prepared by suitable methods known in the art. For example, such compositions can be prepared by solution processing, milling, extruding, polymerizing components including monomers of Formula I, Formula II, and/or Formula III in the presence of a biologically active agent, and combinations thereof.

Compositions including heteroatom-containing polymers as disclosed herein (e.g., with or without a biologically active agent) can further include additional components. Examples of such additional components include fillers, dyes, pigments, inhibitors, accelerators, viscosity modifiers, wetting agents, buffering agents, stabilizers, biologically active agents, polymeric materials, excipients, and combinations thereof.

Medical devices that include one or more heteroatom-containing polymers such as polyketals as disclosed herein and a biologically active agent can have a wide variety of uses. In such devices, the biologically active agent is preferably disposed in the one or more polymers. As used herein, the term “disposed” is intended to be broadly interpreted as inclusive of dispersed, dissolved, suspended, or otherwise contained at least partially therein or thereon.

For example, such devices can be used to deliver a biologically active agent to a tissue by positioning at least a portion of the device including the one or more polymers proximate the tissue and allowing the one or more polymers to biodegrade and deliver the biologically active agent disposed therein. For another example, such devices can be used to control the release rate of a biologically active agent from a medical device by disposing the biologically active agent in at least one of the one or more polymers.

Heteroatom-containing polymers such as polyketals as disclosed herein can hydrolyze (e.g., biodegrade) to form a variety of hydrolysis products. Such polymers can typically be hydrolyzed in an environment including water under conditions effective to hydrolyze the polymer. For example, when the polymer is hydrolyzed under physiological conditions, the hydrolysis products can be delivered to a tissue.

For example, polymers having at least two consecutive repeat units of Formula VIII connected in head-to-tail orientations (e.g., homopolymers or block copolymers of monomers of Formula I, II, or III) can hydrolyze to form one or more hydrolysis products selected from the group consisting of: a compound of the formula (Formula X)

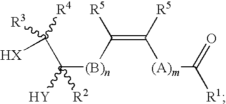

a compound of the formula (Formula XI)

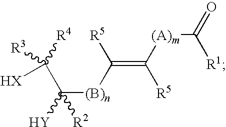

and combinations thereof, wherein each X and Y independently represents O, S, or NR^{∂}; each A and B independently represents an optional organic linking group; m and n are independently zero or one; each R¹ independently represents a carbon-bonded organic group; each R², R³, R⁴, R⁵, and R⁷ independently represents H or an organic group; and two or more of R¹, R², R³, R⁴, R⁵, and R⁷ can optionally be joined to each other to form one or more rings.

For another example, polymers having at least two consecutive repeat units of Formula VIII connected in head-to-head and/or tail-to-tail orientations (e.g., homopolymers or block copolymers of monomers of Formula I, II, or III) can hydrolyze to form one or more hydrolysis products selected from the group consisting of: a compound of the formula (Formula XII)

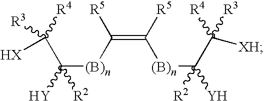

a compound of the formula (Formula XIII)

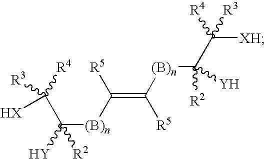

a compound of the formula (Formula XIV)

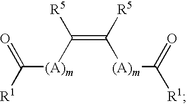

a compound of the formula (Formula XV)

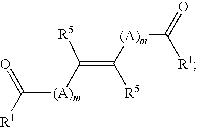

and combinations thereof, wherein each X and Y independently represents O, S, or NR⁷; each A and B independently represents an optional organic linking group; m and n are independently zero or one; each R¹ independently represents a carbon-bonded organic group; each R², R³, R⁴, R⁵, and R⁷ independently represents H or an organic group; and two or more of R¹, R², R³, R⁴, R⁵, and R⁷ can optionally be joined to each other to form one or more rings.

For another example, polymers having at least two consecutive repeat units of Formula IX connected in head-to-tail orientations (e.g., hydrogenated homopolymers or block copolymers of monomers of Formula I, II, or III) can hydrolyze to form one or more hydrolysis products comprising a compound of the formula (Formula XVI)

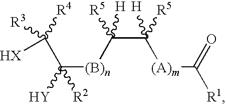

wherein each X and Y independently represents O, S, or NR⁷; each A and B independently represents an optional organic linking group; m and n are independently zero or one; each R¹ independently represents a carbon-bonded organic group; each R², R³, R⁴, R⁵, and R⁷ independently represents H or an organic group; and two or more of R¹, R², R³, R⁴, R⁵, and R⁷ can optionally be joined to each other to form one or more rings.

For another example, polymers having at least two consecutive repeat units of Formula IX connected in head-to-head and/or tail-to-tail orientations (e.g., hydrogenated homopolymers or block copolymers of monomers of Formula I, II, or III) can hydrolyze to form one or more hydrolysis products selected from the group consisting of: a compound of the formula (Formula XVII)

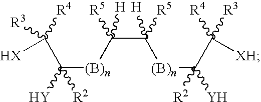

a compound of the formula (Formula XVIII)

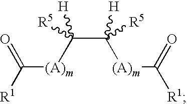

and combinations thereof, wherein each X and Y independently represents O, S, or NR⁷; each A and B independently represents an optional organic linking group; m and n are independently zero or one; each R¹ independently represents a carbon-bonded organic group; each R², R³, R⁴, R⁵, and R⁷ independently represents H or an organic group; and two or more of R¹, R², R³, R⁴, R⁵, and R⁷ can optionally be joined to each other to form one or more rings.

The present disclosure is illustrated by the following examples. It is to be understood that the particular examples, materials, amounts, and procedures are to be interpreted broadly in accordance with the scope and spirit of the disclosure as set forth herein.

### EXAMPLES

2,7-Dioxanorbornene compounds. As an example of a method for making 2,7-dioxanorbornene compounds, a Diels-Alder reaction is run using 2,5-dimethyl furan (i.e., a diene) and dimethyl ketone (i.e., a dieneophile) as reactants. A stoichiometric mixture of the starting materials is charged in a high pressure reactor, and heated to a standard temperature for the reaction to proceed. Upon the completion of the reaction, the resulting material is purified via distillation.

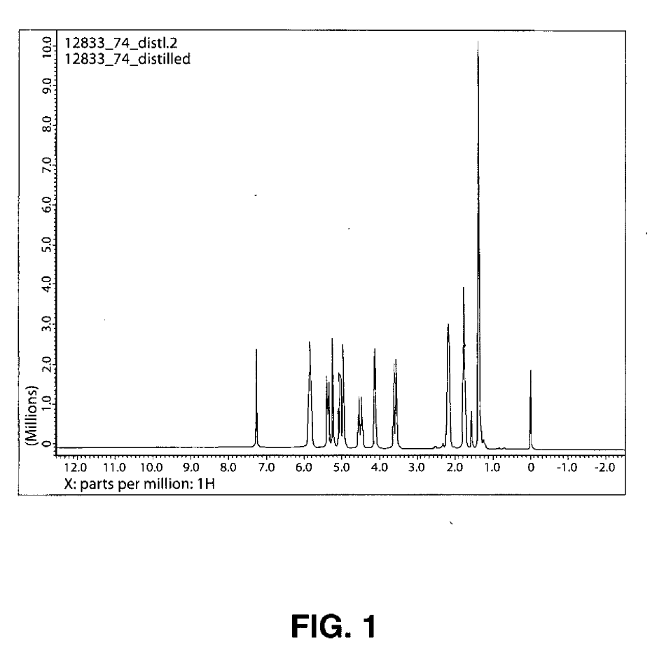

2-Methyl-2-(3-butenyl)-5-vinyl-1,3-dioxolane. A mixture of 5-hexen-2-one (9.8 g, Aldrich, H13001) and 3,4-dihydroxy-1-butene (8.8 g, Aldrich, catalog number 488216) was dissolved in 40 mL toluene in a dry round bottom flask. Into the solution, 10 mg p-toluenesulfonic acid was added. The flask was then equipped with Dean-Stark tube and was heated to 110° C. (oil bath) and then to 130° C. After collecting about 25 mL of toluene and water, the heating was stopped, and into the reaction flask, two drops of triethylamine was added. The reaction mixture was subsequently diluted was diethyl ether (100 mL) and the organic layer was washed with water (100 mL, twice). After drying over magnesium sulfate, the solution was rotary evaporated to remove diethyl ether and the resulting organic material was distilled. (38-40° C., 1.7 mmHg). The proton nuclear magnetic resonance (¹H-NMR) spectrum of the resulting organic material is illustrated in FIG. 1.

Polymerization I. A 2,7-dioxanorbornene compound (20 grams) is dissolved in anhydrous toluene (100 mL) in a dry round bottom flask equipped with a nitrogen inlet and a thermometer. The flask is cooled to about −10° C. under slightly excess pressure of nitrogen. A solution of Grubbs Catalyst (CAS No. 246047-72-3 available from Sigma-Aldrich, St. Louis, Mo., Item No. 569747) in toluene (2 mL of 0.1 M.) is added. The polymerization can be checked by the increase of viscosity, and/or gel permeation chromatography. The resulting Polymer I is purified via precipitation.

Metathesis Polymerization II. 2-Methyl-2-(3-butenyl)-5-vinyl-1,3-dioxolane (20 grams) is dissolved in anhydrous toluene (100 mL) in a dry round bottom flask, which is equipped with nitrogen inlet and thermometer. The flask is cooled to about −10° C. under slightly excess pressure of nitrogen. A solution of Grubbs Catalyst in toluene (2 mL of 0.1 M. Aldrich catalog number 569747) is added. The polymerization can be checked by the increase of viscosity, and/or gel permeation chromatography. The resulting polymer is purified via precipitation.

Iodination of Polymer I. The unsaturated polymers can be modified by functionalizing the carbon-carbon double bonds. This example illustrates that the material reacts with hydrohalogenic acids to introduce iodine atoms into the polymer. Polymer 1 (10 grams) is dissolved in 100 mL of methylene chloride in a 250 mL flask. The flask is kept at room temperature with magnetic stirring. Into the flask, a stream of hydroiodide is introduced to saturation. The reaction is monitored by ¹H-NMR, and upon reaction completion, the product is isolated via precipitation.

Hydrogenation of Polymer I. Conversion of polymer I into a polymer with saturated backbone is achieved by shaking it under hydrogen at room temperature and at atmospheric pressure in the presence of a platinum or a palladium catalyst. Into a 100 mL dry flask, platinum catalyst (100 mg, Aldrich catalog number 205958) and polymer I are dissolved in N,N-dimethylformamide (DMF). The flask is attached to the adaptor of the atmospheric hydrogenation apparatus, and kept at room temperature. The flask is filled with hydrogen and shaken until hydrogen uptake ceases. The catalyst is filtered off and the product is purified via precipitation.

The complete disclosure of all patents, patent applications, and publications, and electronically available material cited herein are incorporated by reference. The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims.

1-33. (canceled)

34. A polymer comprising two or more repeat units selected from the group consisting of:
a repeat unit of the formula (Formula VIII): 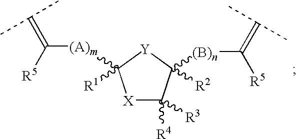
a repeat unit of the formula (Formula IX): 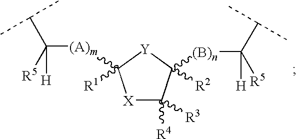
and
combinations thereof;
wherein:
each X and Y independently represents O, S, or NR⁷;
each A and B independently represents an optional organic linking group;
m and n are independently zero or one;
each R¹ independently represents a carbon-bonded organic group;
each R², R³, R⁴, R⁵, and R⁷ independently represents H or an organic group; and
two or more of R¹, R², R³, R⁴, R⁵, and R⁷ can optionally be joined to each other to form one or more rings.

35. (canceled)

36. (canceled)

37. A polymer according to claim 34 wherein R¹ and R² are oriented cis about the illustrated 5-membered heterocyclic ring for at least one repeat unit.

38. A polymer according to claim 34 wherein R¹ and R² are oriented trans about the illustrated 5-membered heterocyclic ring for at least one repeat unit.

39. A polymer according to claim 34 wherein R¹ and R² are oriented cis about the illustrated 5-membered heterocyclic ring for at least a first repeat unit and trans about the illustrated 5-membered heterocyclic ring for at least a second repeat unit.

40. A polymer according to claim 34 wherein R¹ and R² are oriented cis about the illustrated 5-membered heterocyclic ring for all the repeat units of Formula VIII and Formula IX, when present.

41. A polymer according to claim 34 and 38 wherein R¹ and R² are oriented trans about the illustrated 5-membered heterocyclic ring for all the repeat units of Formula VIII and Formula IX, when present.

42. A polymer according to claim 34 wherein the polymer is a copolymer.

43. A polymer according to claim 42 wherein the copolymer further comprises repeat units selected from the group consisting of crosslinkable repeat units, crosslinked repeat units, repeat units having imagable groups, repeat units having latent reactive sites, and combinations thereof.

44. A polymer according to claim 42 wherein the copolymer further comprises repeat units selected from the group consisting of non-cyclic alkenes, monocyclic alkenes, polycyclic alkenes, non-cyclic dienes, monocyclic dienes, polycyclic dienes, non-cyclic polyenes, monocyclic polyenes, polycyclic polyenes, and combinations thereof.

45. A polymer according to 42 wherein the copolymer is selected from the group consisting of random copolymers, alternating copolymers, block copolymers, graft copolymers, and combinations thereof.

46. A polymer according to 42 wherein the copolymer is a block copolymer, and at least one block of the block copolymer is a polyketal block comprising the two or more repeat units selected from the group consisting of repeat units of Formula VIII, repeat units of Formula IX, and combinations thereof.

47. A polymer according to claim 46 wherein at least one other block of the block copolymer is a poly(lactone) block comprising repeat units selected from the group consisting of alpha-hydroxy alkanoates, beta-hydroxy alkanoates, gamma-hydroxy alkanoates, delta-hydroxy alkanoates, epsilon-hydroxy alkanoates, carbonates, acetals, and combinations thereof.

48. A polymer according to claim 46 wherein at least one other block of the block copolymer is a poly(orthoester) block.

49. A polymer according to claim 46 wherein at least one other block of the block copolymer is a poly(alkyleneglycol) block comprising alkylene glycol repeat units.

50. A polymer according to claim 34 wherein the polymer is biodegradable.

51. A polymer according to claim 34 wherein the polymer is radiopaque.

52. A polymer according to claim 34 wherein the polymer has antimicrobial properties.

53. A polymer according claim 34 wherein the polymer is a drug delivery matrix, a tissue bulking agent, a tissue replacement agent, a tissue repair agent, a surgical void filler, an agent used to prevent surgical adhesions, or a combination thereof.

54-64. (canceled)

65. A polymer hydrolysis product selected from the group consisting of:
a compound of the formula (Formula X) 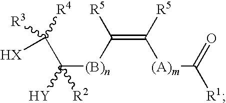
a compound of the formula (Formula XI) 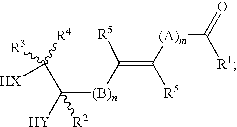
a compound of the formula (Formula XII) 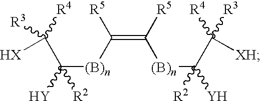
a compound of the formula (Formula XIII) 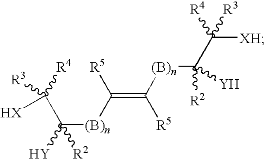
a compound of the formula (Formula XIV) 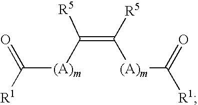
a compound of the formula (Formula XV) 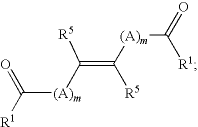
a compound of the formula (Formula XVI) 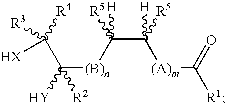
a compound of the formula (Formula XVII) 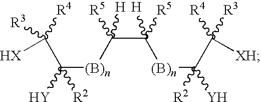
a compound of the formula (Formula XVIII) 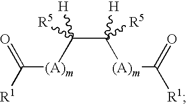
and combinations thereof,
wherein:
each X and Y independently represents O, S, or NR⁷;
each A and B independently represents an optional organic linking group;
m and n are independently zero or one;
each R¹ independently represents a carbon-bonded organic group;
each R², R³, R⁴, R⁵, and R⁷ independently represents H or an organic group; and
two or more of R¹, R², R³, R⁴, R⁵, and R⁷ can optionally be joined to each other to form one or more rings.

66. A method of hydrolyzing a polymer comprising:
placing a polymer according to claim 34 in an environment comprising water under conditions effective to hydrolyze the polymer and produce one or more hydrolysis products.

67. (canceled)
